(19) United States
(12) Patent Application Publication
(10) Pub. No.: US 2011/0216769 A1
(43) Pub. Date: Sep. 8, 2011

(54) Dynamic Path Selection

(75) Inventors: Subramanian Lakshmanan, San Jose, CA (US); Kung-Ling Ko, Union City, CA (US); Sathish Gnanasekaran, Sunnyvale, CA (US); Venkata Pramod Balakavi, San Jose, CA (US)

(73) Assignee: BROCADE COMMUNICATIONS SYSTEMS, INC., San Jose, CA (US)

(21) Appl. No.: 12/719,321

(22) Filed: Mar. 8, 2010

(51) Int. Cl. H04L 12/56

(52) U.S. Cl. 370/392

(57) ABSTRACT

A switch/router dynamically selects a path from multiple available paths between a source destination pair for a frame. A hash function generates a hash value from frame parameters such as source ID, destination ID, exchange ID, etc. The hash value is given as an input to a plurality of range comparators where each range comparator has a range of values associated with it. If the hash value falls within a range associated with a range comparator, that range comparator generates an in-range signal. A path selector module detects which range comparator has generated the in-range signal, and determines a path associated with that range comparator from previously stored information. The frame is transmitted via the selected path. The ranges associated with each range comparator can be non-overlapping and unequal in size. The number of range comparators can be equal to a number of selected multiple paths.

### BACKGROUND OF THE INVENTION

1. Field of the Invention

The present invention relates generally to networks. Particularly, the present invention relates to dynamic selection of routing paths.

2. Description of the Related Art

Storage networks can comprise several Fibre Channel switches interconnected in a fabric topology. These switches are interconnected by a number of inter-switch links (ISLs), which carry both data and control information. The control path provides connectivity among the switching elements and presents the fabric as a single entity to the end devices. The data paths provide throughput to the end devices connected to the fabric.

Paths available between a pair of switches within a fabric are determined during system initialization and/or during changes in fabric configuration, such as the addition or removal of a switch. In a typical network, more than one path may be available to transmit frames between a source-destination pair. This can allow the source switch to potentially distribute frame traffic, destined for the same destination switch, over two or more such paths. In some cases, the source switch may distribute traffic over multiple paths that have equal associated cost, e.g., the same number of hops from source to destination. These multiple paths with equal costs may have unequal bandwidths associated with them.

Traditional schemes of distributing traffic over multiple paths rely on the modulo N method, where N is the number of multiple paths. For example, if the source switch selects four multiple paths over which to distribute traffic destined to the same destination switch, the modulo N scheme will equally distribute traffic over the four available paths. Traffic may be distributed on per packet/frame basis. In such cases, traffic is distributed such that the packets/frames destined for the same destination are evenly distributed over the multiple paths. Traffic may also be distributed on the basis of exchanges or transaction. In such cases, the number of exchanges/transactions between the source and the destination are evenly distributed over the available multiple paths.

The modulo N scheme is usually implemented by performing a modulo N operation on one parameter or a combination of parameters of a frame and determining the result. Because the set of possible outputs of a modulo N operation, assuming N is an integer, is integers 0 to (N−1), each member of the set can be assigned to a path between the source and destination pair. So, for example, if there are three possible paths between a source and destination, a modulo 3 operation on a frame will result in values of 0, 1, or 2. Therefore, 0 can be assigned to path 1, 1 can be assigned to path 2, and 2 can be assigned to path 3. If the modulo 3 operation on a frame results in 0, that frame is sent via path 1; if the modulo 3 operation on another frame results in 1, then that frame is sent via path 2; and so on.

However some traditional methods tend to treat each path equally, regardless of their respective bandwidths, latencies, congestions, etc. For example, if three paths are available between a source and a destination, and the effective bandwidths of the three paths are 17 Gbps, 8 Gbps, and 1 Gbps, the modulo N scheme (modulo 3, in this example) will distribute frames evenly over the three paths. Therefore, links with higher bandwidths—17 Gbps and 8 Gbps—may remain underutilized or the lower bandwidth link—1 Gbps—may become overutilized. Other traditional methods take bandwidth into account, but the granularity in distribution of traffic is still undesirable.

Thus a path selection scheme is needed that can more flexibly distribute traffic over multiple paths between a source-destination pair.

### SUMMARY OF THE INVENTION

Fabrics and networks having multiple interconnected switches can provide multiple paths between a source and destination device pair. A switch or router can carry out load balancing by distributing traffic over the available multiple paths. Each of the multiple paths can have different bandwidths, latencies, congestions, etc. associated with them. Furthermore, two or more of the multiple paths can have equal costs associated with them.

The switch uses a load balancer circuit to distribute frames over multiple paths. The load balancer circuit includes a hash function that generates a hash value of parameters of a given frame. For example, the hash function generates a hash value of a concatenation of the source ID, destination ID, and exchange ID of the frame. The hash function can be a CRC, cryptographic hash function, randomizing function, etc. The generated hash value can be input to a plurality of range comparators. Each range comparator has a range of values associated with it. The ranges associated with the range comparators can be non-overlapping. If the generated hash value falls within the range of values associated with a range comparator, that range comparator generates an “in-range” signal. The total number of range comparators can be equal to a number of multiple paths between the source and destination pair.

Outputs of all range comparators are fed to a path selection module. The path selection module includes information associating the range comparators to multiple paths available between the source and destination pair. If a range comparator returns a in-range signal, the path selector determines the associated path. The frame is then outputted from the appropriate output port that transmits the frame via the determined path.

The sizes of the ranges associated with the range comparators can be unequal. A relatively larger size of the range of a range comparator associated with a path will result in relatively more traffic transmitted via that path. This can allow the router to asymmetrically distribute traffic over a given set of multiple paths by varying the size of the ranges of the range comparators. Thus the router can balance the load over the multiple paths based on various criteria such as available bandwidth, latencies, congestions, etc., associated with each path. Further, if repetitive network traffic results in relatively close hash values, the ranges can be altered to provide a desired balance.

### BRIEF DESCRIPTION OF THE DRAWINGS

The present invention has other advantages and features which will be more readily apparent from the following detailed description of the invention and the appended claims, when taken in conjunction with the accompanying drawings, in which:

FIG. 1 illustrates the a Fibre Channel network communication system according to an embodiment of the present invention;

FIG. 2 shows a detailed view of a Fibre Channel switch according to an embodiment of the present invention;

FIGS. 3A and 3B illustrate block diagrams of a load balancer circuit and a range comparator, respectively, according to an embodiment of the present invention;

### DETAILED DESCRIPTION OF THE PREFERRED EMBODIMENTS

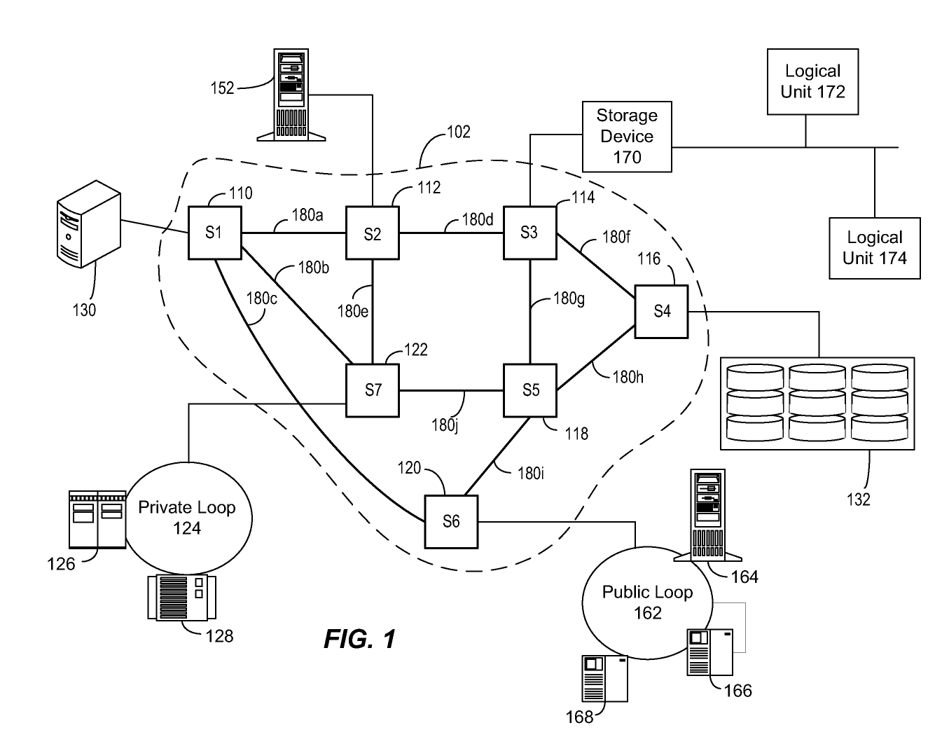

FIG. 1 illustrates a Fibre Channel network 100 including various network, storage, and user devices. It is understood that Fibre Channel is only used as an example and other network architectures, such as Ethernet, FCoE, iSCSI, and the like, could be utilized. Furthermore, the network 100 can represent a “cloud” providing on-demand network access to a shared pool of configurable computing resources (e.g., networks, servers, storage, applications, and services). The network can also represent a converged network such as Fibre Channel over Ethernet. Generally, in the preferred embodiment the network 100 is connected using Fibre Channel connections (e.g., optical fiber and coaxial cable). In the embodiment shown and for illustrative purposes, the network 100 includes a fabric 102 comprised of six different switches S1 110, S2 112, S3 114, S4 116, S5 118, S6 120, and S7 122. It will be understood by one of skill in the art that a Fibre Channel fabric may be comprised of one or more switches.

A variety of devices can be connected to the fabric 102. A Fibre Channel fabric supports both point-to-point and loop device connections. A point-to-point connection is a direct connection between a device and the fabric. A loop connection is a single fabric connection that supports one or more devices in an “arbitrated loop” configuration, wherein signals travel around the loop through each of the loop devices. Hubs, bridges, and other configurations may be added to enhance the connections within an arbitrated loop.

On the fabric side, devices are coupled to the fabric via fabric ports. A fabric port (F_Port) supports a point-to-point fabric attachment. A fabric loop port (FL_Port) supports a fabric loop attachment. Both F_Ports and FL_Ports may be referred to generically as Fx_Ports. Typically, ports connecting one switch to another switch are referred to as expansion ports (E_Ports). In addition, generic ports may also be employed for fabric attachments. For example, G_Ports, which may function as either E_Ports or F_Ports, and GL_Ports, which may function as either E_Ports or Fx_Ports, may be used.

On the device side, each device coupled to a fabric constitutes a node. Each device includes a node port by which it is coupled to the fabric. A port on a device coupled in a point-to-point topology is a node port (N_Port). A port on a device coupled in a loop topology is a node loop port (NL_Port). Both N_Ports and NL_Ports may be referred to generically as Nx_Ports. The label N_Port or NL_Port may be used to identify a device, such as a computer or a peripheral, which is coupled to the fabric.

In the embodiment shown in FIG. 1, fabric 102 includes switches S1 110, S2 112, S3 114, S4 116, S5 118, S6 120, and S7 122 that are interconnected. Switch S7 122 is attached to private loop 124, which is comprised of devices 126 and 128. Switch S2 112 is attached to device 152. Switch S3 114 is attached to device 170, which has two logical units 172, 174 attached to device 170. Typically, device 170 is a storage device such as a RAID device, which in turn may be logically separated into logical units illustrated as logical units 172 and 174. Alternatively the storage device 170 could be a JBOD or just a bunch of disks device, with each individual disk being a logical unit. Switch S6 120 is attached to public loop 162, which is formed from devices 164, 166 and 168 being communicatively coupled together. Switch S1 110 is attached to a user device 130, which may also provide a user interface. Switch S4 116 is attached to storage device 132, which can be a JBOD. Finally, switch S5 118 completes the fabric and can be disconnected from devices outside the fabric. Although not explicitly shown, the network 100 can include one or more zones. A zone indicates a group of source and destination devices allowed to communicate with each other.

Switches S1 110, S2 112, S3 114, S4 116, S5 118, S6, 120, and S7 122 are connected with one or more inter-switch links (ISLs). Switch S1 110 can be connected to switches S2 112, S7 122, and S6 120, via ISLs 180a, 180b, and 180c, respectively. Switch S2 112 can be connected to switches S3 114 and S7 122 by ISLs 180d and 180e. Switch S3 114 can be connected to switches S4 116 and S5 118 via ISLs 180f and 180g, respectively. Switch S4 116 can be connected to switch S5 118 via ISL 180h. Switch S5 118 can be connected to switches S6 120 and S7 122 via ISLs 180i and 180j. Note that although only single links between various switches have been shown, links between any two switches can include multiple ISLs. The fabric can use link aggregation or trunking to form single logical links comprising multiple ISLs between two switches. For example, if 180a comprised of three 2 Gbps ISLs, the three ISLs can be aggregated into a single logical link between switches S1 110 and S2 112 with a bandwidth equal to the sum of bandwidth of the individual ISLs, i.e. 6 Gbps. It is also conceivable to have more than one logical links between two switches where each logical link is composed of one or more trunks. The fabric 102 with multiple switches interconnected with ISLs can provide multiple paths with multiple bandwidths for devices to communicate with each other.

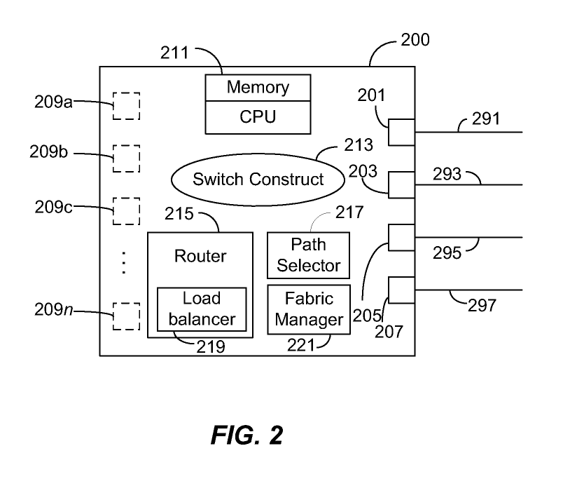

FIG. 2 illustrates a logical block diagram of an exemplary switch 200. Switch 200 can represent any of the switches in fabric 102 of FIG. 1. Switch 200 can be connected to various other switches via ISLs 291, 293, 295, and 297. Each ISL terminates at the respective E_Ports 201, 203, 205, and 207. Switch 200 can have additional E/F/FL/B_Ports (209a-209n) for connecting to various fabric components and endpoints. Switch 200 can include a central processing unit (CPU) module 211 for controlling switch operation. Additionally, the switch 200 can include a path selector 217 for determining paths from source switch to a destination switch. The path selector 217 can determine a set of multiple paths that can be used to load balance traffic from the source switch to a destination switch.

For example, referring to FIG. 1, multiple paths exist between switches S1 110 and switch S5 118. Some of these paths are S1 110-S2 112-S3 114-S5 118, S1 110-S2 112-S7 122-S5 118, S1 110-S7 122-S5 118, S1 110-S6 120-S5 118, etc. The path selector 217 can select the complete set of paths from switch S1 to switch S5, or only a subset. Two or more of the selected paths may even have equal costs associated with them. For example, paths S1 110-S2 112-S3 114-S5 118 and S1 110-S2 112-S7 122-S5 118 have equal cost of 3 hops. The path selector can also employ the fabric shortest path first algorithm in determining these multiple equal cost paths between a source destination pair. In addition, the cost may be based additionally or alternatively on various other network and link parameters such as bandwidth, latency, etc. However, embodiments described herein can include multiple paths of variable cost.

The switch 200 can also include a router module 215 for routing incoming frames at input ports to appropriate output ports. The router can also include a load balancer circuit or module 219 that determines a single path from a selected set of multiple paths that a frame can take from the switch 200 to a destination switch in the fabric. The router module 215 can control the switch construct 213 such that frames are routed to the appropriate output interface.

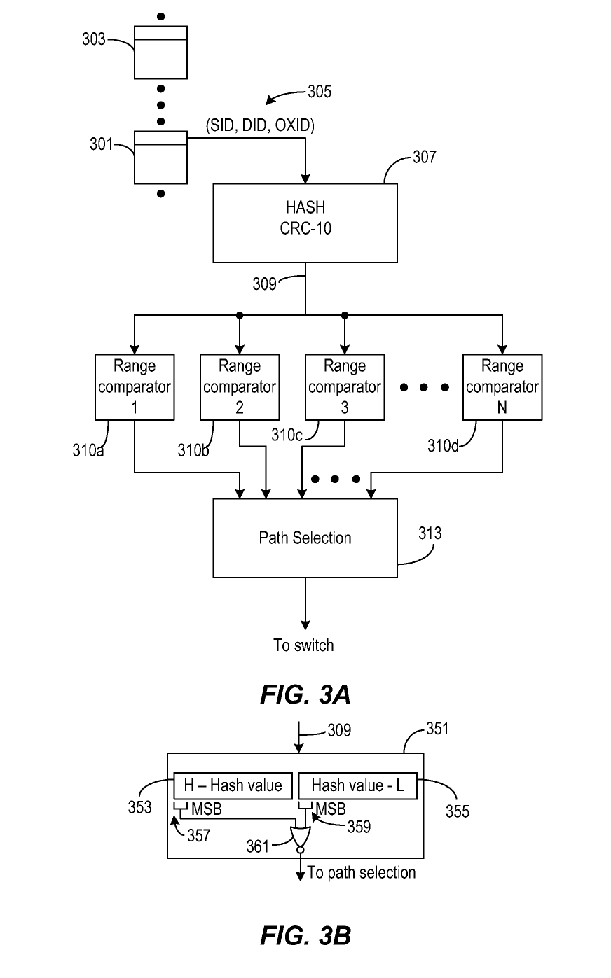

FIG. 3A illustrates an exemplary load balancer circuit 219 for determining the path taken by an outgoing frame based on preset ranges. Each frame in the input buffer queue is processed to determine header information. The header of frame 301 can be processed to determine the source ID (SID), destination ID (DID), and an originating exchange ID (OXID) associated with the frame 301. The parameters selected from the frame 301 are not limited to SID, DID, and OXID. For example, the load balancer 219 can also consider sequence ID, receiver ID (RXID), receiver port (RX port), source fabric ID (SFID), destination fabric ID (DFID), etc., of the frame. Alternatively, the load balancer can exclude the SID associated with the frame. Each of the parameters of frame 301 can have a certain bit length. For example, the SID and DID can each be 24 bits long and the OXID can be 16 bits long. Bit values of the selected parameters are concatenated to form a single word. As shown in FIG. 3A, the SID, DID and OXID are concatenated to form a single word (SID, DID, OXID) having length of 64 bits. As another example, the concatenation of (SID, DID, OXID, RXID, RX port ID, SFID, DFID) can have a total bit length of 100. Furthermore, the concatenation can include additional “seed” bits, which may be a fixed bit sequence of random value in order to impart randomness when all other parameters of two frames are equal. The seed bits may also be associated with a particular processor chip, with each processor chip having its own unique seed value. The order of concatenation SID-DID-OXID shown in FIG. 3A is merely an example, and the selected parameters can be concatenated in any order. The resulting concatenated word can be denoted as “frame ID.”

The frame ID 305 is input to a hashing module 307. Hashing functions are well known in the art, and hashing module 307 can include any one of the well known hash functions, e.g., cryptographic hash functions, CRC, randomizing functions, etc. In FIG. 3A, the exemplar hash module 307 uses a CRC-10 function to create a 10 bit hash value 309 of the 64 bit frame ID 305. Typically, the hash module 307 outputs a hash value with uniform probability. In other words, the hash module 307 can map the frame ID 305 to any one of the 1024 possible hash value with equal probability. However, any particular value of the frame ID will be mapped to the same 10 bit hash value. Therefore, frames belonging to the same exchange between the source destination pair will be routed via the same path. Note that an exchange defines a logical communication connection between two devices. Within each exchange, sequences of frames are delivered to the receiver in order that they were sent from the transmitting device. Therefore, by including OXID in the determination of frame ID, frames associated with the same exchange can be delivered in order to the destination.

The computed hash value 309 can be fed to range comparators 310a-d. Each range comparator can represent a range that corresponds to a single path among multiple paths from the source switch to the destination switch. For example, range comparators 310a-d can represent multiple paths between switches S1 110 and S5 118 (FIG. 1). Each range comparator 310a-d can compare the hash value 309 to this assigned range. The ranges can be non-overlapping and the cumulative ranges of all the range comparators 310a-d will generally include all the possible values that the hash value can take. For example, the cumulative range of the range comparators 310a-d can be 0-1023. Range comparator 310a can have a range of 0-500, range comparator 310b can have a range of 501-610, range comparator 310c can have a range of 611-650, and range comparator 310d can have a range of 651-1023. The ranges can be set based on the various properties of the paths associated with those ranges. For example, larger bandwidth paths can have larger ranges associated with them, while paths experiencing large queuing delays can have smaller ranges. A person skilled in the art will appreciate that by varying the ranges of the range comparator 310a-d, the probability that a hash value 309 will fall in that range can be varied. Therefore, if the load balancer determines that traffic via a particular path needs to be reduced, the range of the range comparator associated with that path can be appropriately reduced. In other words, the load balancer can dynamically achieve asymmetric distribution of traffic over a given set of paths.

Additionally, if only limited items are used to develop the frame ID 305, such as just SID and DID, and if the majority of the traffic is between a limited number of source-destination pairs, in certain cases the hash values may differ only be small amounts. If a more normal spacing were to be used, this could result in an imbalanced situation. By having the flexibility to set the ranges, this situation can be solved by narrowing the ranges until the loads are balanced to a desired amount.

Because of non-overlapping ranges of range comparators 310a-d, the hash value will fall within the range of only one range comparator. For example, assuming the exemplar ranges of the range comparators stated above, and assuming the exemplar hash value 309 is 400, range comparator 310a will be the only range comparator that will generate a “in-range” signal indicating that the hash value 309 is within its range. The path selection module 313 detects which one of the range comparators 310a-d has generated an in-range signal. The path selector module 313 maintains information matching each of the range comparators 310a-d outputs to its associated path. Therefore, if range comparator 310a generates an in-range signal, the path selection module 313 will determine the associated path, and send a signal to the switch construct 213 (FIG. 2) so that the frame 301 is sent to the output interface associated with the selected path. Typically the selected output interface is the one connecting the switch 200 to the switch that is next in the selected path.

The load balancing module 219 shown in FIG. 3A can be implemented in hardware, or software, or a combination of hardware and software as known in the art. Preferably, because the path selection is done on the fly, some modules may be implemented in hardware for achieving lower latencies. For example, FIG. 3B illustrates an exemplar range comparator 351. The range comparator 351 can include bitwise signed integer subtracters 353 and 355 having a word size equal to one bit more that the number of bits used to represent the hash value 309. H and L denote the ceiling (upper limit) and floor (lower limit) values of the range for the range comparator. H and L can be stored in modifiable registers within the hardware. The first subtracter 353 subtracts the hash value 309 from the ceiling, while the second subtracter 355 subtracts the floor from the hash value 309. The outputs of the most significant bit (MSB) 357 of the subtracter 353 is fed to one input of the NOR gate 361. Similarly MSB 359 of subtracter 355 is fed to the second input of the NOR gate 361. Output of the NOR gate 361 forms the output of the range comparator 351, and can be fed to the path selection module 313 (FIG. 3A).

Note that because the subtracters 353 and 355 are signed integer subtracters, the MSB of the output of each subtracter will result in a bit value of ‘1’ whenever the result of the subtraction is a negative number and will result in a bit value of ‘0’ whenever the result of the subtraction is a positive number. Therefore, the NOR gate 361 of the range comparator 351 will output a 1 if and only if the hash value 309 lies within the range L-H (including values L and H). This ‘1’ signal can represent an in-range signal that is fed to the path selection module 313. All other range comparators, for which the hash value 309 lies outside their specified range, at least one of the inputs to their respective NOR gates will be a ‘1’, resulting in a ‘0’ NOR gate output.

In a second embodiment, the range comparator 351 can include an XOR gate instead of the NOR gate 361 in addition to the subtracter 353 subtracting H from the hash value 309 (instead of subtracting the hash value 309 from the H). In this embodiment, it should be recognized that if the hash value 309 is equal to the upper limit value H of a range, then the MSB values of both the subtracters will be ‘0’. For example, if the range for a comparator has been defined as L=100 and H=200, and the hash value 309 is 200, then both the subtracters (hash value −H, and hash value −L) will have the values of their MSBs equal to ‘0’. Therefore, the output of the XOR gate will also be ‘0’ despite the hash value being within the range of the range comparator. However, this can be easily mitigated by increasing the upper limit to be an incremental value higher than 200, say 201. This value can be equal to the L value of the subsequent range. For example, the ranges can be 0-101, 101-201, 201-301, and so on. This ensures that even if the hash value is equal to a high value (e.g. 101) at least one range comparator (e.g., range 101-201) will have its XOR gate output as ‘1’.

In the preferred embodiment there are sixteen range comparators, that value selected as a balance between logic size and the probable number of paths available. If fewer than sixteen range comparators are needed, the unneeded units can be disabled.

Alternatively, the range comparators 310a-d and or the path selection module 313 can be implemented as look up tables stored within memory 211 (FIG. 2) of the switch. The hash value 309 can be used as the lookup value and the stored value is the desired path. This provides for a very large number of possible paths and intricate path selections but at the expense of increased logic area and potential slower operation.

Although the router module 215 and the path selector 217 have been shown as separate modules, their functionality can be combined within a single entity. For example, the functionality of path selector 217 can be included in the router module 215. Furthermore, the path selector 217 and router module 215 can share functionality. For example, the load balancer can be part of the path selector 217 while the router module 215 uses the output of the load balancer to determine the appropriate output port for the frame.

Information regarding load balancing can be distributed to one or more switches within the fabric or network. For example, all of the switches S1-S7 can include identical load balancing information such as ranges of the range comparators. By distributing this information, intermediate switches can configure their routing tables in accordance to the paths specified. Thus, a path selected for a frame at the source switch can be consistently selected by every intermediate switch when the intermediate switch encounters the same frame.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A switch comprising:
a hashing module for determining a hash value associated with one or more parameters of a frame, the hash value being larger than a number of possible paths for the frame;
a plurality of range comparators receiving the hash value as input, each range comparator having an associated range of values, wherein one of the plurality of range comparators generates an in-range signal if the hash value falls within the range of values associated with the one of the plurality of range comparators; and
a path selector for selecting one of the number of possible paths between a source destination pair for the frame, the selected path corresponding to the in-range signal generated by the one of the plurality of range comparators.

2. The switch of claim 1, wherein at least two of the plurality of range comparators have unequal associated ranges of values.

3. The switch of claim 1, wherein a total number of active range comparators of the plurality of range comparators is equal to a total number of plurality of paths between the source and destination pair.

4. The switch of claim 1, wherein the one or more parameters of the frame includes an exchange ID of the frame.

5. The switch of claim 1, wherein each of the plurality of paths between the source and destination pair have equal costs associated with them.

6. The switch of claim 1, wherein the range of values associated with each of the plurality of range comparators is programmable.

7. A method for distributing traffic, the method comprising:
generating a hash value from one or more parameters of a frame, the hash value being larger than a number of possible paths for the frame;
determining one range of values from a plurality of ranges of values, the one range of values including the hash value;
selecting one of the number of paths for the frame, the selected path corresponding to the one range of values that includes the hash value.

8. The method of claim 7, wherein at least two of the plurality of ranges of values have unequal sizes.

9. The method of claim 7, wherein a total number of the plurality of ranges of values is equal to a total number of the plurality of paths between the source and destination pair.

10. The method of claim 7, wherein the one or more parameters of the frame includes an exchange ID of the frame.

11. The method of claim 7, wherein each of the plurality of paths between the source and destination pair have equal costs associated with them.

12. The method of claim 7, further comprising modifying at least one range of values from the plurality of ranges of values from a first range to a second range.
